(19) United States
(12) Patent Application Publication
(10) Pub. No.: US 2006/0184769 A1
(43) Pub. Date: Aug. 17, 2006

(54) Localized generation of global flush requests while guaranteeing forward progress of a processor

(75) Inventors: Michael S. Floyd, Austin, TX (US); Hung Q. Le, Austin, TX (US); Larry S. Leitner, Austin, TX (US); Brian W. Thompto, Austin, TX (US)

Correspondence Address: IBM CORPORATION (SYL);C/O SYNNESTVEDT & LECHNER LLP, 1101 MARKET STREET, SUITE 2600, PHILADELPHIA, PA, 19107, US

(73) Assignee: International Business Machines Corporation, Armonk, NY (US)

(21) Appl. No.: 11/056,692

(22) Filed: Feb. 11, 2005

(51) Int. Cl. G06F 9/40

(52) U.S. Cl. 712/216

(57) ABSTRACT

Localized generation of global flush requests while providing a means for increasing the likelihood of forward progress in a controlled fashion. Local hazard (error) detection is accomplished with a trigger network situated between execution units and configurable state machines that track trigger events. Once a hazardous state is detected, a local detection mechanism requests a workaround flush from the flush control logic. The processor is flushed and a centralized workaround control is informed of the workaround flush. The centralized control blocks subsequent workaround flushes until forward progress has been made. The centralized control can also optionally send out a control to activate a set of localized workarounds or reduced performance modes to avoid the hazardous condition once instructions are re-executed after the flush until a configurable amount of forward progress has been made.

### BACKGROUND OF THE INVENTION

1. Field of the Invention

The present invention relates generally to an improved data processing system and in particular to a method and apparatus for enabling a workaround to bypass errors or other anomalies in the data processing system.

2. Description of the Related Art

Modern processors commonly use a technique known as pipelining to improve performance. Pipelining is an instruction execution technique that is analogous to an assembly line. Consider that instruction execution often involves the sequential steps of fetching the instruction from memory, decoding the instruction into its respective operation and operand(s), fetching the operands of the instruction, applying the decoded operation on the operands (herein simply referred to as “executing” the instruction), and storing the result back in memory or in a register. Pipelining is a technique wherein the sequential steps of the execution process are overlapped for a sub-sequence of the instructions. For example, while the CPU is storing the results of a first instruction of an instruction sequence, the CPU simultaneously executes the second instruction of the sequence, fetches the operands of the third instruction of the sequence, decodes the fourth instruction of the sequence, and fetches the fifth instruction of the sequence. Pipelining can thus decrease the execution time for a sequence of instructions.

Another technique for improving performance involves executing two or more instructions in parallel, i.e., simultaneously. Processors that utilize this technique are generally referred to as superscalar processors. Such processors may incorporate an additional technique in which a sequence of instructions may be executed out of order. Results for such instructions must be reassembled upon instruction completion such that the sequential program order or results are maintained. This system is referred to as out of order issue with in-order completion.

The ability of a superscalar processor to execute two or more instructions simultaneously depends upon the particular instructions being executed. Likewise, the flexibility in issuing or completing instructions out-of-order can depend on the particular instructions to be issued or completed. There are three types of such instruction dependencies, which are referred to as: resource conflicts, procedural dependencies, and data dependencies. Resource conflicts occur when two instructions executing in parallel tend to access the same resource, e.g., the system bus. Data dependencies occur when the completion of a first instruction changes the value stored in a register or memory, which is later accessed by a later completed second instruction.

During execution of instructions, an instruction sequence may fail to execute properly or to yield the correct results for a number of different reasons. For example, a failure may occur when a certain event or sequence of events occurs in a manner not expected by the designer. Further, an error also may be caused by a misdesigned circuit or logic equation. Due to the complexity of designing an out of order processor, the processor design may logically miss-process one instruction in combination with another instruction, causing an error. In some cases, a selected frequency, voltage, or type of noise may cause an error in execution because of a circuit not behaving as designed. Errors such as these often cause the scheduler in the microprocessor to “hang”, resulting in execution of instructions coming to a halt. A hang may also result due to a “live-lock”—a situation where the instructions may repeatedly attempt to execute, but cannot make forward progress due to a hazard condition. For example, in a simultaneous multi-threaded processor, multiple threads may block each other if there is a resource interdependency that is not properly resolved. Errors do not always cause a “hang”, but may also result in a data integrity problem where the processor produces incorrect results. A data integrity problem is even worse than a “hang” because it may yield an indeterminate and incorrect result for the instruction stream executing.

These errors can be particularly troublesome when they are missed during simulation and thus find their way onto already manufactured hardware systems. In such cases, large quantities of the defective hardware devices may have already been manufactured, and even worse, may already be in the hands of consumers. For such situations, it was desirable to formulate workarounds which allow such problems to be bypassed so that the defective hardware elements can be used. One such workaround is described in U.S. Pat. No. 6,543,003 to Floyd et al. In accordance with U.S. Pat. No. 6,543,003, the operations of a processor are monitored to detect a hang condition. The detected hang conditions are triggers which trigger the injection of “flush” commands to the processor pipeline which cause the instructions in the execution units to be cleared. The instructions being processed at the time of the trigger are then refetched and reprocessed.

Having the ability to flush the processor pipeline is an attractive workaround since the flush can clear out the bad state that is detected. Since the flush-and-refetch process can be performed so that it has minimal effect on the overall operation of the processor, it is a very attractive option, even with the potential reduction in processing performance, when compared with the high cost and inconvenience of recovering all of the faulty processors and replacing them.

To work around specific problematic scenarios that would normally result in an error condition it is desirable to flush the processor pipeline based on a configurable trigger condition based on internal processor events. The use of a configurable trigger in some existing sytems provides the ability to work around problems that do not result in hangs and the ability to detect conditions that would eventually have been resulted in a hang. However, existing mechanisms for introducing configurable trigger based flushes cannot guarantee “forward progress” when performing these flushing operations. A trigger based flush generation may repeatedly cause the flush to repeat each time the flushed instructions are refetched and processed, because the processor may encounter a flush trigger again before the flushed-and-refreshed instructions have had the opportunity to complete execution. This results in an indefinite hang situation, in which the processor essentially loops without progressing forward, which is clearly unacceptable.

Accordingly, it would be advantageous to have a method and apparatus for bypassing errors in a microprocessor, including those that would cause it to hang or that would result in a loss of data integrity, by flushing the processor pipeline based on a configurable event, while providing a means for safely executing the flushed instructions when they are re-executed and allowing the processor to make forward progress.

### SUMMARY OF THE INVENTION

The present invention allows localized generation of global flush requests while providing a means for increasing the likely hood of forward progress in a controlled fashion. Local hazard (error) detection is accomplished with a trigger network situated between execution units and configurable state machines that track trigger events. Once a hazardous state is detected, a local detection mechanism requests a workaround flush from the flush control logic. The processor is flushed and a centralized workaround control is informed of the workaround flush. The centralized control blocks subsequent workaround flushes until forward progress has been made. The centralized control can also optionally send out a control to activate a set of localized workarounds or reduced performance modes to avoid the hazardous condition once instructions are re-executed after the flush until a configurable amount of forward progress has been made.

### BRIEF DESCRIPTION OF THE DRAWINGS

FIG. 1 is a block diagram illustrating a data processing system in which the present invention may be implemented;

FIG. 2 is a diagram of a portion of a processor core in accordance with a preferred embodiment of the present invention; and

FIGS. 3 and 4 are flowcharts illustrating the basic operations performed by the flush controller 212 and the workaround controller 218, respectively of one embodiment of the present invention.

### DETAILED DESCRIPTION OF THE PREFERRED EMBODIMENTS

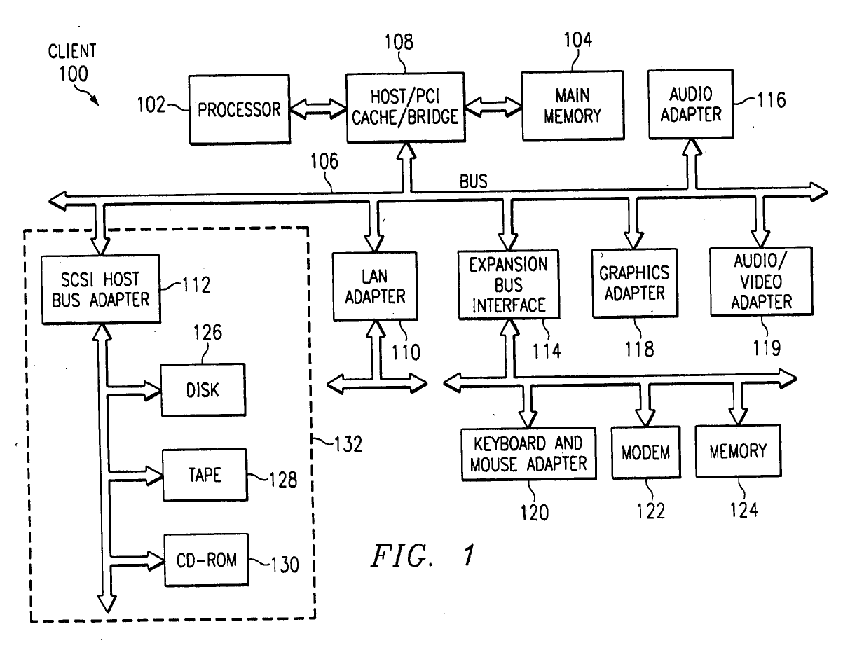

With reference now to FIG. 1, a block diagram illustrates a data processing system in which the present invention may be implemented. Data processing system 100 is an example of a client computer. Data processing system 100 employs a peripheral component interconnect (PCI) local bus architecture. Although the depicted example employs a PCI bus, other bus architectures such as Accelerated Graphics Port (AGP) and Industry Standard Architecture (ISA) may be used. Processor 102 and main memory 104 are connected to PCI local bus 106 through PCI bridge 108. PCI bridge 108 also may include an integrated memory controller and cache memory for processor 102. Additional connections to PCI local bus 106 may be made through direct component interconnection or through add-in boards. In the depicted example, local area network (LAN) adapter 110, SCSI host bus adapter 112, and expansion bus interface 114 are connected to PCI local bus 106 by direct component connection. In contrast, audio adapter 116, graphics adapter 118, and audio/video adapter 119 are connected to PCI local bus 106 by add-in boards inserted into expansion slots. Expansion bus interface 114 provides a connection for a keyboard and mouse adapter 120, modem 122, and additional memory 124. Small computer system interface (SCSI) host bus adapter 112 provides a connection for hard disk drive 126, tape drive 128, and CD-ROM drive 130. Typical PCI local bus implementations will support three or four PCI expansion slots or add-in connectors.

An operating system runs on processor 102 and is used to coordinate and provide control of various components within data processing system 100 in FIG. 1. The operating system may be a commercially available operating system such as AIX, which is available from International Business Machines Corporation. Instructions for the operating system and applications or programs are located on storage devices, such as hard disk drive 126, and may be loaded into main memory 104 for execution by processor 102.

Those of ordinary skill in the art will appreciate that the hardware in FIG. 1 may vary depending on the implementation. Other internal hardware or peripheral devices, such as flash ROM (or equivalent nonvolatile memory) or optical disk drives and the like, may be used in addition to or in place of the hardware depicted in FIG. 1. Also, the processes of the present invention may be applied to a multiprocessor data processing system.

For example, data processing system 100, if optionally configured as a network computer, may not include SCSI host bus adapter 112, hard disk drive 126, tape drive 128, and CD-ROM 130, as noted by dotted line 132 in FIG. 1 denoting optional inclusion. The data processing system depicted in FIG. 1 may be, for example, an IBM RISC/System 6000 system, a product of International Business Machines Corporation in Armonk, N.Y., running the Advanced Interactive Executive (AIX) operating system.

The depicted example in FIG. 1 and above-described examples are not meant to imply architectural limitations.

The present invention provides a method and apparatus for bypassing flaws in a processor, such as (but not limited to) flaws that hang the instruction sequencing or instruction execution within a processor core or that would result in a loss of processor result integrity. The present invention provides a mechanism that allows for localized event or “trigger” monitoring throughout the processor core to initiate the workaround flush within the processor and implements a workaround “safe mode” for a programmable notion of forward progress after the flush (e.g. a number of instruction completions) in an attempt to avoid the design bug detected or warned by the trigger. As is known in the art, when a flush occurs, instructions currently being processed by execution units are cancelled or thrown away. In other words, “flush” means to “cancel” or throw away the effect of the instructions being executed. Then, execution of the instructions is restarted. Flush operations may be implemented by using currently available flush mechanisms for processor cores currently implemented to back out of mispredicted branch paths.

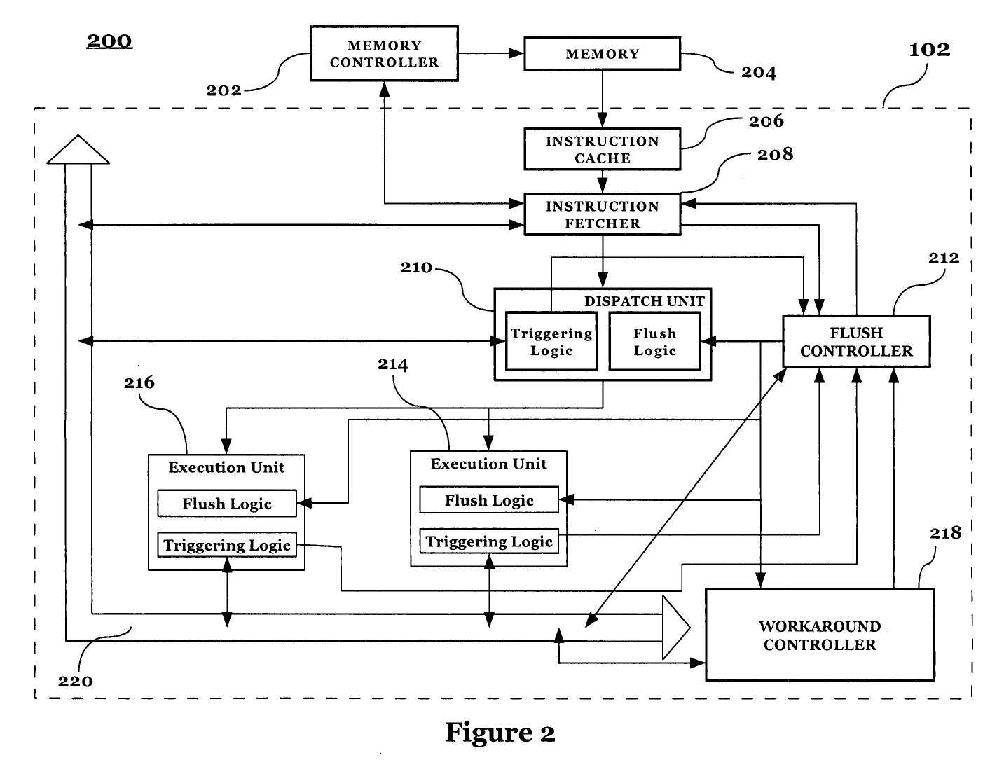

The mechanism of the present invention may be implemented within processor 102. With reference next to FIG. 2, a diagram of a portion of a processor core is depicted in accordance with a preferred embodiment of the present invention. Section 200 illustrates a portion of a processor core for a processor, such as processor 102 in FIG. 1. Only the components needed to illustrate the present invention are shown in section 200. Other components are omitted in order to avoid obscuring the invention.

Referring to FIG. 2, processor 102 is connected to a memory controller 202 and a memory 204 which may also include a L2 cache. As is well known, the memory 202 and memory controller 204 function to provide storage, and control access to the storage, for the processor 102.

The processor 102 of the present invention includes an instruction cache 206, and instruction fetcher 208. An instruction fetcher 208 maintains a program counter and fetches instructions from instruction cache 206 and from more distant memory 204 that may include a L2 cache. The program counter of instruction fetcher 208 comprises an address of a next instruction to be executed. The L1 cache 206 is located in the processor and contains data and instructions preferably received from an L2 cache in memory 204. Ideally, as the time approaches for a program instruction to be executed, the instruction is passed with its data, if any, first to the L2 cache, and then as execution time is near imminent, to the L1 cache. Thus, instruction fetcher 208 communicates with a memory controller 202 to initiate a transfer of instructions from a memory 204 to instruction cache 206. Instruction fetcher 208 retrieves instructions passed to instruction cache 206 and passes them to an instruction dispatch unit 210.

Instruction dispatch unit 210 receives and decodes the instructions fetched by instruction fetcher 208. The dispatch unit 210 may extract information from the instructions used in determination of which execution units must receive the instructions. The instructions and relevant decoded information may be stored in an instruction buffer or queue (not shown) within the dispatch unit 210. The instruction buffer within dispatch unit 210 may comprise memory locations for a plurality of instructions. The dispatch unit 210 may then use the instruction buffer to assist in reordering instructions for execution. For example, in a multi-threading processor, the instruction buffer may form an instruction queue that is a multiplex of instructions from different threads. Each thread can be selected according to control signals received from control circuitry within dispatch unit 210 or elsewhere within the processor 102. Thus, if an instruction of one thread becomes stalled, an instruction of a different thread can be placed in the pipeline while the first thread is stalled.

Dispatch unit 210 dispatches the instruction to execution units (214 and 216). For purposes of example, but not limitation, only two execution units are shown in FIG. 2. In a superscalar architecture, execution units (214 and 216) may comprise load/store units, integer Arithmetic/Logic Units, floating point Arithmetic/Logic Units, and Graphical Logic Units, all operating in parallel. Dispatch unit 210 therefore dispatches instructions to some or all of the executions units to execute the instructions simultaneously. Execution units (214 and 216) comprise stages to perform steps in the execution of instructions received from dispatch unit 210. Data processed by execution units (214 and 216) are storable in and accessible from integer register files and floating point register files not shown. Data stored in these register files can also come from or be transferred to an on-board data cache or an external cache or memory.

Dispatch unit 210, and other control circuitry (not shown) include instruction sequencing logic to control the order that instructions are dispatched to execution units (214 and 216). Such sequencing logic may provide the ability to execute instructions both in order and out-of-order with respect to the sequential instruction stream. Out-of-order execution capability can enhance performance by allowing for younger instructions to be executed while older instructions are stalled.

Each stage of each of execution units (214 and 216) is capable of performing a step in the execution of a different instruction. In each cycle of operation of processor 102, execution of an instruction progresses to the next stage through the processor pipeline within execution units (214 and 216). Those skilled in the art will recognize that the stages of a processor “pipeline” may include other stages and circuitry not shown in FIG. 2. In a multi-threading processor, each pipeline stage can process a step in the execution of an instruction of a different thread. Thus, in a first cycle, a particular pipeline stage 1 will perform a first step in the execution of an instruction of a first thread. In a second cycle, next subsequent to the first cycle, a pipeline stage 2 will perform a next step in the execution of the instruction of the first thread. During the second cycle, pipeline stage 1 performs a first step in the execution of an instruction of a second thread. And so forth.

The program counter of instruction fetcher 208 may normally increment to point to the next sequential instruction to be executed, but in the case of a branch instruction, for example the program counter can be set to point to a branch destination address to obtain the next instruction. In one embodiment, when a branch instruction is received, instruction fetcher 208 predicts whether the branch is taken. If the prediction is that the branch is taken, then instruction fetcher 208 fetches the instruction from the branch target address. If the prediction is that the branch is not taken, then instruction fetcher 208 fetches the next sequential instruction. In either case, instruction fetcher 208 continues to fetch and send to dispatch unit 210 instructions along the instruction path taken. After many cycles, the branch instruction is executed in execution units (214 and 216) and the correct path is determined. If the wrong branch path was predicted, then flush controller 212 is notified of the mispredicted branch condition. Flush controller 212 then sends control signals to the execution units (214 and 216), dispatch unit 210, and instruction fetcher 208 that invalidate instructions from the pipeline that are younger that the branch. Each of the execution units (214 and 216), dispatch unit 210, and instruction fetcher 208 have flush handling logic that processes the flush signals from flush controller 212. In a simultaneous multithreaded processor, the flush logic will distinguish between threads when processing a flush request such the each thread may be flushed individually.

It can be seen by one skilled in the art how the circuitry required to handle a branch flush, both in the flush controller, and in the processor pipeline may be adapted to flush all instructions as a bug workaround. Thus, in a preferred embodiment, the flush controller 212 and flush logic for each unit may be modified (if necessary) to handle a pipeline flush initiated for such a reason. The flush controller 212 may be a grouping of centralized control circuitry or a distributed control circuitry, whereby multiple elements of flush control logic may reside in physically distant locations but are designed to systematically process flush requests.

In one embodiment, the workaround flush may be initiated by localized triggering logic distributed throughout the processor core. Trigger logic may reside within instruction fetcher 208, dispatch unit 210, execution units (214 and 216), flush controller 212 and in other locations throughout the core. The triggering logic is designed to have access to local and inter-unit indications of processor state, and uses such state to generate a trigger indication requesting a workaround flush to flush controller 212. Inter-unit indications of processor state may be passed between units via inter-unit triggering bus 220. Triggering bus 220 may have a static set of indications from each processor unit, or in a preferred embodiment, may have a configurable set of processor state indications.

The configuration of triggering logic to generate workaround flush requests and the configuration of the set of processor states available on triggering bus 220 are determined once there is a known hardware error for which a workaround is desired. The triggers can then be programmed to look for the particular workaround scenario. These triggers can be direct or can be event sequences such as A happened before B, or more complex, such as A happened within three cycles of B. Depending on the nature of the error, the triggers may be selected to detect that the error just occurred, or that it may be about to occur.

An example error condition for which a workaround flush may be desired is the case of an instruction queue overflow within an execution unit (214 or 216). Continuing with this example, let us consider the case where an instruction queue in execution unit 214 has a design bug that allows a dispatched instruction to be discarded when the queue is full. In such a case, instruction processing results may be lost and the instruction program may yield incorrect results. Upon analysis of the failure mechanism it may be determined that a flush of the instructions in the execution pipeline including those in the instruction queue will clear any bad state from the processor and allow for re-execution of the lost instruction. For this example embodiment, execution unit 214 has an internal “instruction-queue-fill” event available to the local triggering logic. Furthermore, triggering logic of execution unit 214 has access to events from dispatch unit 210 via the inter-unit triggering bus. Furthermore, dispatch unit 210 provides a “dispatch-valid” indication that is active whenever an instruction is dispatched. To activate a trigger and cause a workaround flush of the pipeline when the error condition occurs, the triggering logic of execution unit 214 may be configured to look for an internal “instruction-queue-full” event coincident with a remote “dispatch-valid” event. By configuring the local triggering logic as such, the problem scenario can be detected, and a trigger can be generated and sent to flush controller 212 to cause a flush that will clear up the processor's bad state. One skilled in the art will recognize how unit designers may select events such as “queue-full” and “dispatch-valid” which are likely to be useful in forming triggers for a workaround flush and may make them available to local unit triggering logic and to the inter-unit triggering bus.

Once a workaround flush request has been made by triggering logic in a processor unit and is received by flush controller 212, the flush controller 212 will initiate a flush of the processor pipeline for all instructions and notify the workaround controller 218.

Workaround controller 218 provides a centralized control for the workaround action and workaround flushing operations being performed by processor 102. When workaround controller 218 is notified of a workaround flush by flush controller 212 it will immediately send an indication back to flush controller 212 to begin blocking subsequent requests for a workaround flush and may optionally begin to send an indication to the processor units to engage a “safe mode” or back-off mode that will be active by the time the flushed instructions are re-executed. Such a “safe-mode” may be required cases where the flushed instructions would normally re-execute and possible encounter the same error condition that initially triggered the workaround flush.

In one embodiment, the workaround controller 218 may activate a “safe mode” of operation by sending a trigger via the inter-unit trigger bus 220. Correspondingly, a processor unit, such as dispatch unit 210 or execution units (214 and/or 216) may be configured to enter a reduced mode of operation when a trigger is active from workaround controller. In a preferred embodiment, various reduced modes of operation may already be defined in processor 102 and may be engaged either statically or dynamically based on a trigger condition, once a defect is discovered. Use of dynamic modes of engagement for such reduced modes of operation is desirable since these modes may measurably hinder processor performance if statically engaged. Further, such modes may not be successful at avoiding an error condition if engaged dynamically without first flushing the processor. Such is the case when a set of triggers is available to detect when the processor is already in a bad state and may be used to cause a flush, while there may be no set of trigger conditions that can predict when a processor may be about to enter a bad state soon enough to avoid the problem by engaging a workaround. So, an important advantage of the present invention is the ability to react to a configurable state which may already be invalid or problematic, and then cause a flush to clear the erroneous state and subsequently modify the execution mode of the processor such that the error state is avoided.

Another important advantage of the present invention is the ability to track forward progress through the instruction stream once a workaround flush has occurred and a reduced mode of execution has been engaged such that the reduced mode of execution may be disengaged once the potential problem sequence of instructions that initiated the workaround flush has past. In one embodiment, this is accomplished with the workaround controller 218. Once the workaround controller 218 detects a workaround flush condition, it also resets a configurable forward progress counter. Such a counter may be implemented with a logical incrementer/decrementer, a linear-feedback-shift-register (LFSR) or any other circuitry that may be used to count events. In a preferred embodiment, the counter can be configured to count various events from the inter-unit trigger bus 220 or a set of statically defined events such as instruction completion. In one embodiment, when an instructions completes the forward progress counter is incremented. Once the counter reaches a configurable limit (such a limit being set based on the nature of the error being bypassed), the workaround controller 218 will disengage the “safe mode” that has been entered, if any, and will re-enable workaround flushes by dropping the blocking indication being sent to the flush controller 212.

In one embodiment of the present invention, processor 102 is a simultaneous multithreaded (SMT) processor, and the facilities of the invention are replicated per thread such that independent workaround actions may be taken on each thread independently. Workaround controller 218 may be replicated per thread, or separate facilities may be kept internal to the workaround controller 218 for tracking each thread. In another embodiment, the per thread facilities of the invention are further extended to provide a configurable mode whereby a flush request from a single thread will initiate a workaround flush for all active threads in the processor.

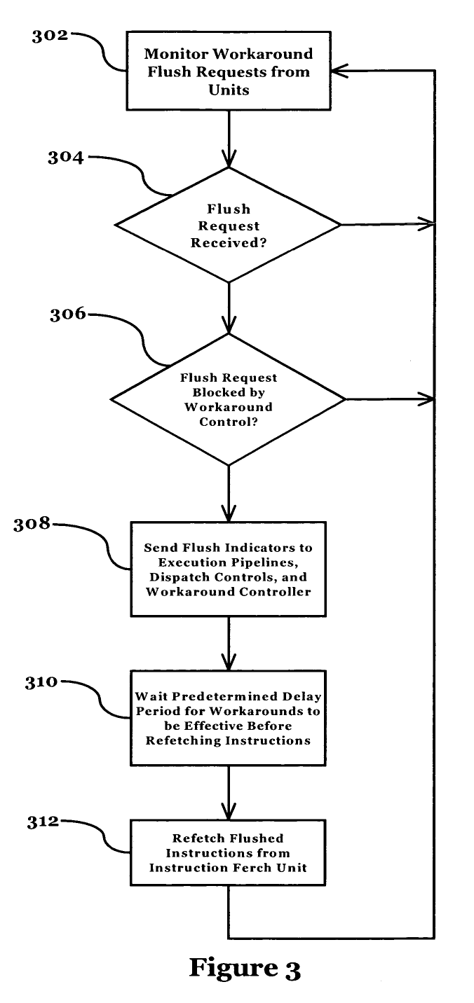

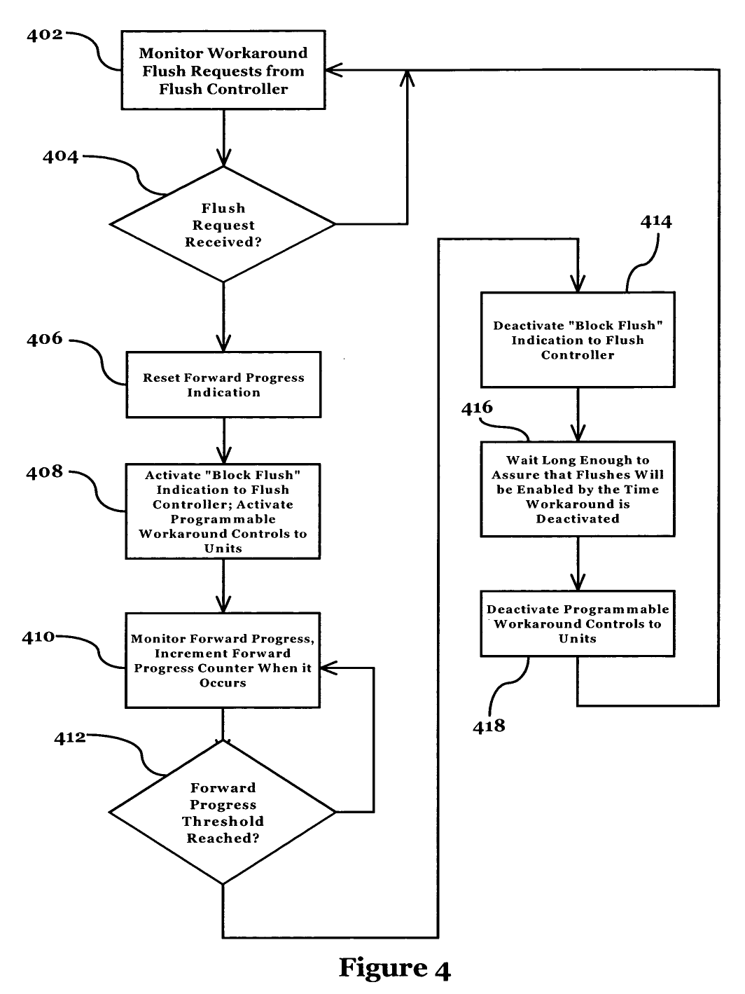

FIGS. 3 and 4 are flowcharts illustrating the basic operations performed by the flush controller 212 and the workaround controller 218, respectively of one embodiment of the present invention. Referring first to FIG. 3, at step 302, the flush controller 212 monitors workaround flush requests from triggering logic contained within the processors units. If no flush requests have been received, the process reverts back to step 302 and continues to monitor the workaround flush requests from the execution units.

If, however, at step 304, a flush request is detected as having been received, at step 306, a determination is made as to whether or not the flush request has been blocked by the workaround controller 218. If the flush request has been blocked by the workaround controller 218, then the process reverts back to step 302 and continues to monitor flush request from the execution units. If, however, at step 306, it is determined that the flush request was not blocked by the workaround controller 218, then the process proceeds to step 308, where the flush indicators are sent to flush the processor pipeline including the execution pipelines, and dispatch controls. An indication that a workaround flush has been initiated is also sent to workaround controller 218.

At step 310, the flush controller 212 waits a predetermined delay period to allow any workaround “safe modes” to be activated by the workaround controller 218 to take effect before refetching the flushed instructions. Once the predetermined delay period has elapsed, at step 312 the flushed instructions are refetched from the instruction fetch unit, and then the process proceeds back to step 302 to continue monitoring workaround flush request from the execution units.

FIG. 4 is a flow diagram illustrating the basic steps performed by the workaround controller 218 when handling a workaround flush. At step 402, the workaround controller 218 monitors any workaround flush requests coming from flush controller 212. If, at step 404, it is determined that no flush requests have been received, the process reverts back to step 402 to continue the monitoring operation.

If, however, at step 414, a flush request is received from the flush controller 212, the process proceeds to step 406, and a forward progress counter contained within workaround controller 218 is reset, thereby initializing the counter to begin a new count. The process then proceeds to step 408, where the workaround controller 218 activates a “block flush” signal and sends it to the flush controller 212. Additionally, programmable workaround controls for use by the execution units are also activated.

At step 410, the workaround controller 218 monitors the forward progress of the processor 102 and its execution units 214 and 216, and increments the forward progress counter whenever forward progress occurs. At step 412, determination is made as to whether or not a threshold amount of forward progress (e.g., a the processing of a predetermined number of instructions) has been reached. If the threshold has not been reached, the process proceeds back to step 410 to continue monitoring the forward progress and incrementing the forward progress counter when forward progress occurs. If, at step 412, is determined that the threshold has been reached, then the process proceeds to step 414, where the “block flushed” signal to the flush controller is deactivated.

At step 416, after waiting long enough to assure that the flushes will be enabled by the time the workaround is deactivated, the process proceeds to step 418, where the workaround controls are deactivated. The process than proceeds back to step 402 to continue monitoring the workaround flush requests from the flush controller.

Without the facility of the present invention for disabling workaround flushes during the “safe mode” following a workaround flush, many triggering configurations that might otherwise work, may result in actually introducing a processor hang condition. This may occur if the triggering logic cannot differentiate between cases where an error condition is actually eminent or may be eminent, and cases where the problem will not occur due to the effects of the workaround flush or the effects of “safe modes” engaged after a workaround flush has been initiated. Therefore, even though a workaround flush in conjunction with a post flush “safe mode” may be sufficient to avoid the problem scenario when the flushed instructions are re-executed, the events that trigger the workaround flush may still occur because the events may activate when the processor reaches a state “close” to that of the known error condition, and the workaround “safe mode” that is engaged may not alter these events. Over-indicating a potential problem condition in this way is likely because events available to the triggering logic of each unit may be limited, and it is highly unlikely that all the required events needed to isolate precisely all possible problem scenarios.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A method of managing the operation of a processor, comprising:
commencing a workaround flush to clear a bad state existing within said processor;
upon commencement of said workaround flush, activating a blocking operation to block the occurrence of additional workaround flushes in said processor;
monitoring the operation of said processor to identify instances of forward progress being made by said processor; and
ceasing the blocking operation once a predetermined amount of forward progress by said processor has been made.

2. The method of claim 1, further comprising:
engaging a configurable safe-mode of operation to avoid any problems caused by said bad state while said blocking operation is activated.

3. The method of claim 2, wherein the commencement of said workaround flush occurs based on the occurrence of a trigger condition.

4. The method of claim 3, wherein said trigger condition comprises the sensing of a condition hazardous to said microprocessor.

5. The method of claim 4, wherein said sensing of a hazardous condition is sensed by local hazard detection logic located within the processor.

6. The method of claim 5, wherein said local hazard detection logic has access to an inter-unit trigger bus, whereby the internal state of the processor can be analyzed by said local hazard detection logic.

7. A system of managing the operation of a processor, comprising:
means for commencing a workaround flush to clear a bad state existing within said processor;
means for activating a blocking operation to block the occurrence of additional workaround flushes in said processor upon commencement of said workaround flush;
means for monitoring the operation of said processor to identify instances of forward progress being made by said processor; and
means for ceasing the blocking operation once a predetermined amount of forward progress by said processor has been made.

8. The system of claim 7, further comprising:
means for engaging a configurable safe-mode of operation to avoid any problems caused by said bad state while said blocking operation is activated.

9. The system of claim 8, wherein the commencement of said workaround flush occurs based on the occurrence of a trigger condition.

10. The system of claim 9, wherein said trigger condition comprises the sensing of a condition hazardous to said microprocessor.

11. The system of claim 10, wherein said sensing of a hazardous condition is sensed by local hazard detection logic located within the processor.

12. The system of claim 5, wherein said local hazard detection logic has access to an inter-unit trigger bus, whereby the internal state of the processor can be analyzed by said local hazard detection logic.

13. A computer program product for managing the operation of a processor, the computer program product comprising a computer-readable storage medium having computer-readable program code embodied in the medium, the computer-readable program code comprising:
computer-readable program code that commences a workaround flush to clear a bad state existing within said processor;
computer-readable program code that activates a blocking operation to block the occurrence of additional workaround flushes in said processor upon commencement of said workaround flush;
computer-readable program code that monitors the operation of said processor to identify instances of forward progress being made by said processor; and
computer-readable program code that ceases the blocking operation once a predetermined amount of forward progress by said processor has been made.

14. The computer program product of claim 13, further comprising:
computer-readable program code that engages a configurable safe-mode of operation to avoid any problems caused by said bad state while said blocking operation is activated.

15. The computer program product of claim 14, wherein the commencement of said workaround flush occurs based on the occurrence of a trigger condition.

16. The computer program product of claim 15, wherein said trigger condition comprises the sensing of a condition hazardous to said microprocessor.

17. The computer program product of claim 16, wherein said sensing of a hazardous condition is sensed by local hazard detection logic located within the processor.

18. The computer program product of claim 17, wherein said local hazard detection logic has access to an inter-unit trigger bus, whereby the internal state of the processor can be analyzed by said local hazard detection logic.
